(19) United States
(12) Patent Application Publication
(10) Pub. No.: US 2014/0207658 A1
(43) Pub. Date: Jul. 24, 2014

(54) PAYMENT SETTLEMENT SYSTEM WITH FEEDBACK

(71) Applicant: Larry Kerr, Moline, IL (US)

(72) Inventor: Larry Kerr, Moline, IL (US)

(21) Appl. No.: 13/749,236

(22) Filed: Jan. 24, 2013

(51) Int. Cl. G06Q 30/00

(52) U.S. Cl. CPC G06Q 30/01
USPC 705/39

(57) ABSTRACT

A method of providing feedback to a user concerning a payment settlement process is provided. User identification information for a user is received. An electronic document associated with a payment transaction for a task completed by the user is received. Electronic processing criterion associated with the payment transaction are identified based on the received user identification information. Whether or not the received electronic document satisfies the identified electronic processing criterion is determined. If the received electronic document satisfies the electronic processing criterion, a notification message is sent to the user indicating that a proper submission of the document associated with the payment transaction has been completed. If the received electronic document does not satisfy the electronic processing criterion, an issue notification message is sent to the user identifying an issue associated with the payment transaction.

### BACKGROUND

Trucking companies may use thousands of drivers to support the transportation of goods to various sites located throughout North America. A driver is typically assigned a shipping load and related shipping documents. Upon delivery of the shipping load, the driver obtains the necessary signature(s) on the shipping documents to evidence delivery of the goods. However, the receiving party typically cannot be billed for the transportation services until the signed shipping documents are received by the billing department of the transportation company. Additionally, there may be other parties to the transaction, such as brokers and third party freight providers, who must receive some or all of the scanned documents as part of the transaction. For example, the broker typically would like to receive, at a minimum, the proof of delivery document for the freight from the driver as soon as possible.

Existing solutions provide remote scanning or photographing of the necessary delivery documents, data entry identifying the document information such as trip number and document type, and sending of the documents for further processing to bill the shipper and ultimately pay the driver. However, as an example, current solutions do not have a process to update the driver concerning the status of the settlement process. As a result, trucking companies receive frequent calls from their drivers related to the status of their payment. These inquiries waste time in the trucking companies' settlement department, cause ill will with drivers if they do not get paid a preconceived amount when they expect to receive it, and limit the ability of a driver to obtain information to those hours when a person is available in the settlement department.

### SUMMARY

In an example embodiment, a method for providing feedback to a user concerning a payment settlement process is provided. User identification information for a user is received. An electronic document associated with a payment transaction for a task completed by the user is received. Electronic processing criterion associated with the payment transaction is identified based on the received user identification information. Whether or not the received electronic document satisfies the identified electronic processing criterion is determined. If the received electronic document does not satisfy the electronic processing criterion, an issue notification message is sent to the user identifying an issue associated with the payment transaction.

In another example embodiment, a computer-readable medium is provided having stored thereon computer-readable instructions that when executed by a computing device, result in the computing device performing the method of providing feedback to a user concerning a payment settlement process.

In yet another example embodiment, a system is provided. The system includes, but is not limited to, a processor, a computer-readable medium operably coupled to the processor, and a communication interface operably coupled to the processor. The computer-readable medium has instructions stored thereon that when executed by the processor, cause the system to perform the method of providing feedback to a user concerning a payment settlement process. The communication interface is configured to receive the user identification information and the electronic document and to send the issue notification message.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 depicts a block diagram of a settlement system in accordance with an illustrative embodiment.

FIG. 2 depicts a block diagram of a payee system of the settlement system of FIG. 1 in accordance with an illustrative embodiment.

FIG. 3 depicts a block diagram of a payer system of the settlement system of FIG. 1 in accordance with an illustrative embodiment.

FIG. 4 depicts a block diagram of a data storage system of the settlement system of FIG. 1 in accordance with an illustrative embodiment.

FIG. 5 depicts a flow diagram illustrating example operations performed by a payee application in accordance with an illustrative embodiment.

FIGS. 6-8 illustrate user interface windows presented under control of the payee application executed by the payee system of FIG. 2 in accordance with an illustrative embodiment.

FIGS. 9a, 9b, and 9c depict a flow diagram illustrating example operations performed by a document processing application in accordance with an illustrative embodiment.

### DETAILED DESCRIPTION

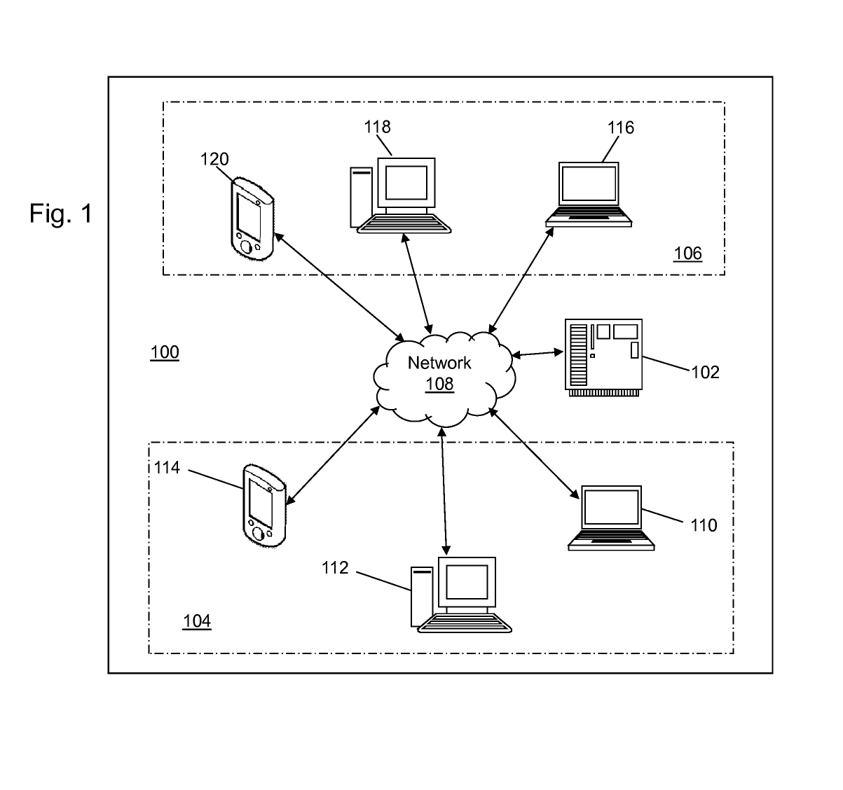

With reference to FIG. 1, a block diagram of a settlement system 100 is shown in accordance with an illustrative embodiment. In the illustrative embodiment, settlement system 100 includes a data storage system 102, one or more payee systems 104, one or more payer systems 106, and a network 108. The systems of settlement system 100 may be distributed remotely from each other. The systems may be associated with specific users or entities or may be available for public use. The one or more payee systems 104 generate one or more documents needed to receive payment for performance of a task such as delivery of goods to a destination by a truck driver. The one or more payer systems 106 receive the generated one or more documents and process the documents to provide payment to the task performer such as the truck driver. Data storage system 102 stores data associated with the generated one or more documents as well as other data and documents associated in general with performance of the task.

Network 108 may include one or more networks of the same or different types. Network 108 can be any type of wired and/or wireless public or private network including a cellular network, a local area network, a wide area network such as the Internet, etc. Network 108 further may be comprised of sub-networks and consist of any number of devices.

Data storage system 102 may include one or more computing devices. The one or more computing devices send and receive signals through network 108 to/from another of the one or more computing devices of data storage system 102, to/from the one or more payee systems 104, and/or to/from the one or more payer systems 106. Data storage system 102 can include any number and type of computing devices that may be organized into subnets. Data storage system 102 may communicate with other computing devices using various transmission media that may be wired or wireless as understood by those skilled in the art. Data storage system 102 may communicate information as a peer in a peer-to-peer network using network 108.

The one or more payee systems 104 may include one or more computing devices. The one or more computing devices of the one or more payee systems 104 send and receive signals through network 108 to/from another of the one or more computing devices of the one or more payee systems 104, to/from data storage system 102, and/or to/from the one or more payer systems 106. The one or more payee systems 104 can include any number and type of computing devices that may be organized into subnets. The one or more computing devices of the one or more payee systems 104 may include computers of any form factor such as a laptop 110, a desktop 112, a smart phone 114, a personal digital assistant, an integrated messaging device, a tablet computer, etc. The one or more payee systems 104 may include additional types of devices. The one or more computing devices of the one or more payee systems 104 may communicate using various transmission media that may be wired or wireless as understood by those skilled in the art. The one or more computing devices of the one or more payee systems 104 further may communicate information as peers in a peer-to-peer network using network 108.

The one or more payer systems 106 may include one or more computing devices. The one or more computing devices of the one or more payer systems 106 send and receive signals through network 108 to/from another of the one or more computing devices of the one or more payer systems 106, to/from data storage system 102, and/or to/from the one or more payee systems 104. The one or more payer systems 106 can include any number and type of computing devices that may be organized into subnets. The one or more computing devices of the one or more payer systems 106 may include computers of any form factor such as a laptop 116, a desktop 118, a smart phone 120, an integrated messaging device, a personal digital assistant, a tablet computer, etc. The one or more payer systems 106 may include additional types of devices. The one or more computing devices of the one or more payer systems 106 may communicate using various transmission media that may be wired or wireless as understood by those skilled in the art. The one or more computing devices of the one or more payer systems 106 further may communicate information as peers in a peer-to-peer network using network 108.

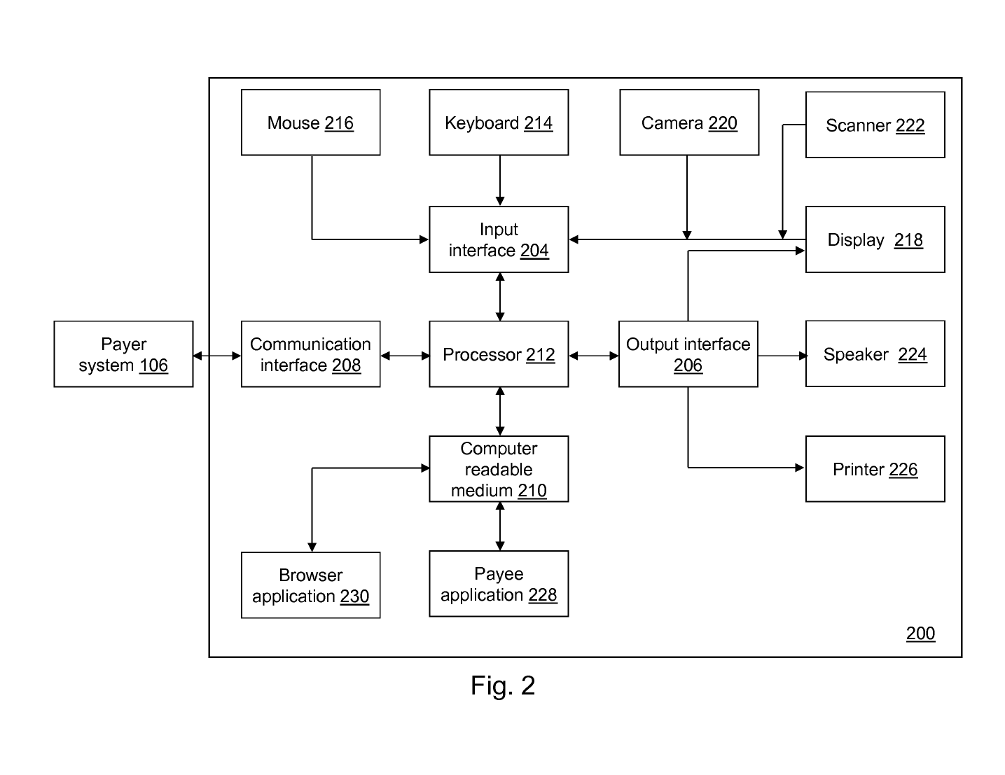

With reference to FIG. 2, a block diagram of a payee system 200 of the one or more payee systems 104 is shown in accordance with an illustrative embodiment. Thus, payee system 200 is an example computing device of the one or more payee systems 104. Payee system 200 may include an input interface 204, an output interface 206, a communication interface 208, a computer-readable medium 210, a processor 212, a keyboard 214, a mouse 216, a display 218, a camera 220, a scanner 222, a speaker 224, a printer 226, a payee application 228, and a browser application 230. Fewer, different, and additional components may be incorporated into payee system 200. The components shown with reference to FIG. 2 are merely for illustration.

Input interface 204 provides an interface for receiving information from the user for entry into payee system 200 as understood by those skilled in the art. Input interface 204 may interface with various input technologies including, but not limited to, keyboard 214, mouse 216, display 218, camera 220, scanner 222, a track ball, a keypad, one or more buttons, etc. to allow the user to enter information into payee system 200 or to make selections presented in a user interface displayed on display 218. The same interface may support both input interface 204 and output interface 206. For example, a display comprising a touch screen supports input from the user and output to the user. Camera 220 may be any of a variety of cameras as understood by those skilled in the art. Scanner 222 may be any of a variety of image scanners as understood by those skilled in the art. Payee system 200 may have one or more input interfaces that use the same or a different input interface technology. One or more of keyboard 214, mouse 216, display 218, camera 220, scanner 222, etc. further may be accessible by payee system 200 through communication interface 208.

Output interface 206 provides an interface for outputting information for review by a user of payee system 200. For example, output interface 206 may interface with various output technologies including, but not limited to, display 218, speaker 224, printer 226, etc. Display 218 may be a thin film transistor display, a light emitting diode display, a liquid crystal display, or any of a variety of different displays as understood by those skilled in the art. Speaker 224 may be any of a variety of speakers as understood by those skilled in the art. Printer 226 may be any of a variety of printers as understood by those skilled in the art. Payee system 200 may have one or more output interfaces that use the same or a different interface technology. One or more of speaker 224, printer 226, etc. further may be accessible by payee system 200 through communication interface 208.

Communication interface 208 provides an interface for receiving and transmitting data between devices using various protocols, transmission technologies, and media as understood by those skilled in the art. Communication interface 208 may support communication using various transmission media that may be wired or wireless. Payee system 200 may have one or more communication interfaces that use the same or a different communication interface technology such as WiFi, Bluetooth, Ethernet, USB, etc. Data and messages may be transferred between the one or more payee systems 104 and the one or more payer systems 106 using communication interface 208. Though not shown, data and messages further may be transferred between the one or more payee systems 104 and data storage system 102 using communication interface 208

Computer-readable medium 210 is an electronic holding place or storage for information so that the information can be accessed by processor 212 as understood by those skilled in the art. Computer-readable medium 210 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., CD, DVD, . . . ), smart cards, flash memory devices, etc. Payee system 200 may have one or more computer-readable media that use the same or a different memory media technology. Payee system 200 also may have one or more drives that support the loading of a memory media such as a CD or DVD as understood by a person of skill in the art.

Processor 212 executes instructions as understood by those skilled in the art. The instructions may be carried out by a special purpose computer, logic circuits, and/or hardware circuits. Thus, processor 212 may be implemented in hardware, firmware, or any combination of these methods and/or in combination with software. The term “execution” is the process of running an application or the carrying out of the operation called for by an instruction. The instructions may be written using one or more programming language, scripting language, assembly language, etc. Processor 212 executes an instruction, meaning that it performs/controls the operations called for by that instruction. Processor 212 operably couples with input interface 204, with output interface 206, with computer-readable medium 210, and with communication interface 208 to receive, to send, and to process information. Processor 212 may retrieve a set of instructions from a permanent memory device and copy the instructions in an executable form to a temporary memory device that is generally some form of RAM. Payee system 200 may include a plurality of processors that use the same or a different processing technology.

Payee application 228 performs operations associated with generating and submitting the one or more documents needed to receive payment for performance of a task such as delivery of goods. Some or all of the operations described herein may be embodied in payee application 228. The operations may be executed using hardware, firmware, software, or any combination of these methods. With reference to the example embodiment of FIG. 2, payee application 228 is implemented in software (comprised of computer-readable and/or computer-executable instructions) stored in computer-readable medium 210 and accessible by processor 212 for execution of the instructions that embody the operations of payee application 228. Payee application 228 may be written using one or more programming languages, assembly languages, scripting languages, etc.

Payee application 228 may be implemented as a Web application. For example, payee application 228 may be configured to receive hypertext transport protocol (HTTP) responses from other computing devices such as those associated with the one or more payer systems 106 and/or data storage system 102 and to send HTTP requests. The HTTP responses may include web pages such as hypertext markup language (HTML) documents and linked objects generated in response to the HTTP requests. Each web page may be identified by a uniform resource locator (URL) that includes the location or address of the computing device that contains the resource to be accessed in addition to the location of the resource on that computing device. The type of file or resource depends on the Internet application protocol. The file accessed may be a simple text file, an image file, an audio file, a video file, an executable, a common gateway interface application, a Java applet, or any other type of file supported by HTTP.

Browser application 230 performs operations associated with retrieving, presenting, and traversing information resources provided by a web application and/or web server as known to those skilled in the art. An information resource is identified by a uniform resource identifier (URI) and may be a web page, image, video, or other piece of content. Hyperlinks in resources enable users to navigate to related resources. Example browser applications include Navigator by Netscape Communications Corporation, Firefox® by Mozilla Corporation, Opera by Opera Software Corporation, Internet Explorer® by Microsoft Corporation, Safari by Apple Inc., Chrome by Google Inc., etc. as known to those skilled in the art. Payee application 228 and browser application 230 may be integrated as understood by a person of skill in the art.

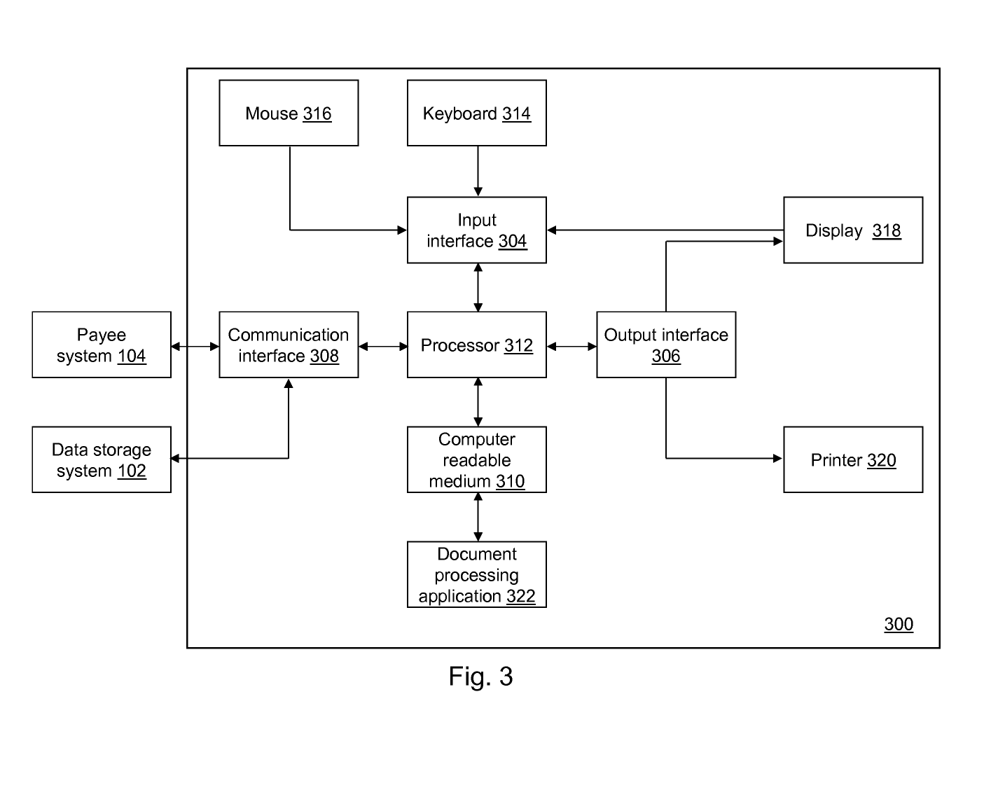

With reference to FIG. 3, a block diagram of a payer system 300 of the one or more payer systems 106 is shown in accordance with an illustrative embodiment. Payer system 300 is an example computing device of the one or more payer systems 106. Payer system 300 may include a second input interface 304, a second output interface 306, a second communication interface 308, a second computer-readable medium 310, a second processor 312, a second keyboard 314, a second mouse 316, a second display 318, a second printer 320, and a document processing application 322. Fewer, different, and additional components may be incorporated into payer system 300.

Second input interface 304 provides the same or similar functionality as that described with reference to input interface 204 of payee system 200. Second output interface 306 provides the same or similar functionality as that described with reference to output interface 206 of payee system 200. Second communication interface 308 provides the same or similar functionality as that described with reference to communication interface 208 of payee system 200. Second computer-readable medium 310 provides the same or similar functionality as that described with reference to computer-readable medium 210 of payee system 200. Second processor 312 provides the same or similar functionality as that described with reference to processor 212 of payee system 200. Second keyboard 314 provides the same or similar functionality as that described with reference to keyboard 214 of payee system 200. Second mouse 316 provides the same or similar functionality as that described with reference to mouse 216 of payee system 200. Second display 318 provides the same or similar functionality as that described with reference to display 218 of payee system 200. Second printer 320 provides the same or similar functionality as that described with reference to printer 226 of payee system 200.

Document processing application 322 performs operations associated with receiving the generated one or more documents and processing the documents to provide payment to the task performer such as the driver. Some or all of the operations described herein may be embodied in document processing application 322. The operations may be executed using hardware, firmware, software, or any combination of these methods. With reference to the example embodiment of FIG. 3, document processing application 322 is implemented in software (comprised of computer-readable and/or computer-executable instructions) stored in second computer-readable medium 310 and accessible by second processor 312 for execution of the instructions that embody the operations of document processing application 322. Document processing application 322 may be written using one or more programming languages, assembly languages, scripting languages, etc.

Document processing application 322 may be implemented wholly or in part as a Web application. For example, document processing application 322 may be configured to accept HTTP requests from client devices such as those associated with the one or more payee systems 104 and data storage system 102 and to send HTTP responses along with optional additional data content which may include web pages such as HTML documents and linked objects in response to the HTTP requests.

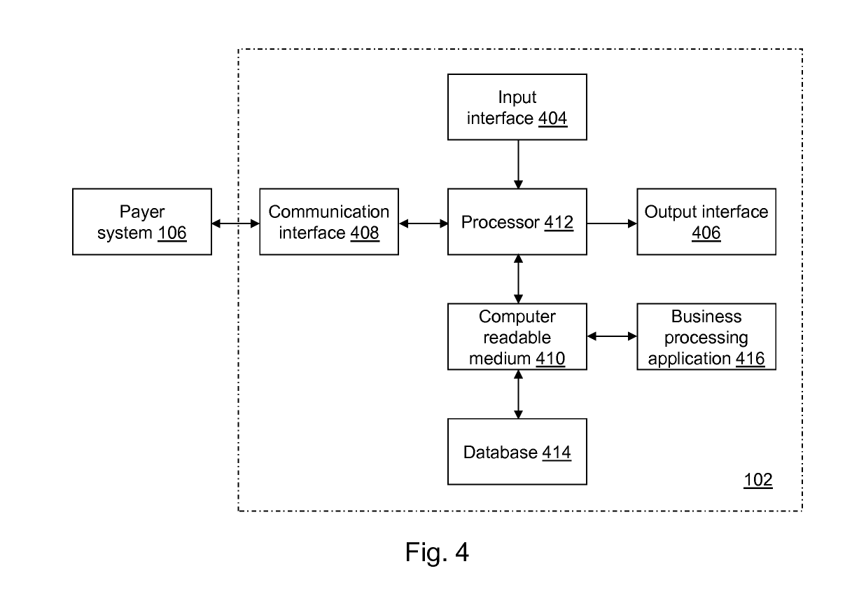

With reference to FIG. 4, a block diagram of data storage system 102 is shown in accordance with an illustrative embodiment. Data storage system 102 may include a computer of any form factor. Data storage system 102 may include a third input interface 404, a third output interface 406, a third communication interface 408, a third computer-readable medium 410, a third processor 412, a database 414, and a business processing application 416. Fewer, different, and additional components may be incorporated into data storage system 102.

Third input interface 404 provides the same or similar functionality as that described with reference to input interface 204 of payee system 200. Third output interface 406 provides the same or similar functionality as that described with reference to output interface 206 of payee system 200. Third communication interface 408 provides the same or similar functionality as that described with reference to communication interface 208 of payee system 200. Third computer-readable medium 410 provides the same or similar functionality as that described with reference to computer-readable medium 210 of payee system 200. Third processor 412 provides the same or similar functionality as that described with reference to processor 212 of payee system 200.

Data storage system 102 includes or can access database 414 either through a direct connection or through network 108 using third communication interface 408. Third computer-readable medium 410 may provide the electronic storage medium for database 414. Database 414 is a data repository for settlement system 100 and may be distributed across one or more computing devices. Database 414 may include a plurality of databases that may be organized into multiple database tiers to improve data management and access. Database 414 may utilize various database technologies and a variety of different formats as understood by those skilled in the art including a file system, a relational database, a system of tables, a structured query language database, etc. Database 414 may be implemented as a single database or as multiple databases stored in different storage locations distributed over the Internet or other heterogeneous storage infrastructures under control of one or more vendors. Open database connectivity protocols may be used to support connectivity between distributed databases of database 414.

Business processing application 416 performs operations associated with accessing database 414 to store or retrieve data and documents associated with automation of one or more aspects of a business process. The functionality provided by business processing application 416 may be integrated into a single application executed at one or more computing devices or distributed among a plurality of applications executed at one or more computing devices as understood by a person of skill in the art. Some or all of the operations described herein may be embodied in business processing application 416. The operations may be executed using hardware, firmware, software, or any combination of these methods. With reference to the example embodiment of FIG. 4, business processing application 416 is implemented in software (comprised of computer-readable and/or computer-executable instructions) stored in third computer-readable medium 410 and accessible by third processor 412 for execution of the instructions that embody the operations of business processing application 416. Business processing application 416 may be written using one or more programming languages, assembly languages, scripting languages, etc.

Business processing application 416 may be implemented wholly or in part as a Web application. For example, business processing application 416 may be configured to accept HTTP requests from client devices such as those associated with the one or more payee systems 104 and the one or more payer systems 106 and to send HTTP responses along with optional additional data content which may include web pages such as HTML documents and linked objects in response to the HTTP requests.

Document processing application 322, payee application 228, and business processing application 416 may save or store data to database 414 and access or retrieve data from database 414. Document processing application 322, payee application 228, and business processing application 416 may be the same or different applications or part of an integrated, distributed application supporting some or all of the same or additional types of functionality as described herein. As an example, the functionality provided by payee application 228 may be provided through an Internet portal supported by document processing application 322. Document processing application 322 further may be implemented as an application designed to interface with business processing application 416. Business processing application 416 may be implemented to support the automation of tasks in the transportation industry such as dispatching, accounting, imaging, mobile communications, financials, logistics, recruiting, safety and compliance, driver performance, etc.

In an alternative embodiment, settlement system 100 need not include data storage system 102. For example, database 414 may be stored in second computer-readable medium 310 of payer system 300. Other levels of integration between the components of settlement system 100 may be implemented without limitation as understood by a person of skill in the art.

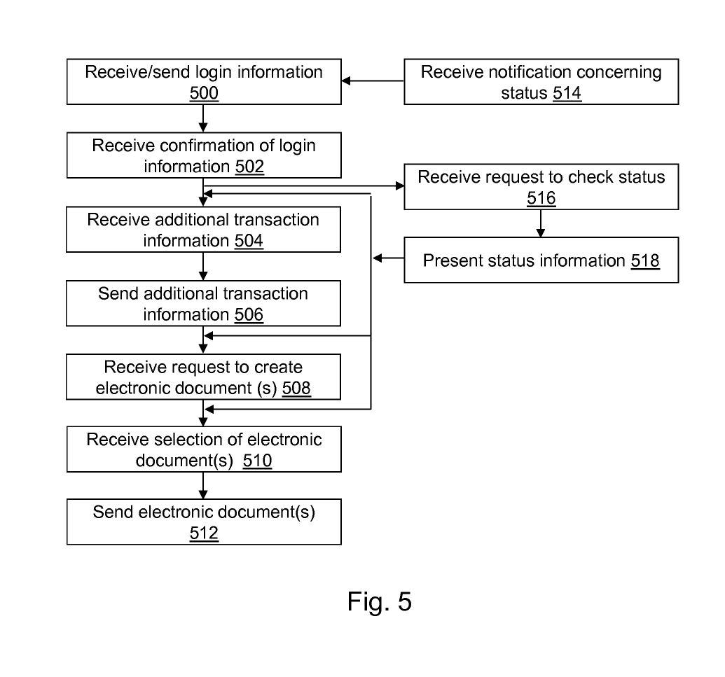

With reference to FIG. 5, example operations associated with payee application 228 are described. Additional, fewer, or different operations may be performed depending on the embodiment. For example, payee application 228 may provide additional functionality beyond the capability to generate and submit the one or more documents needed to receive payment for performance of a task such as the delivery of goods. The order of presentation of the operations of FIG. 5 is not intended to be limiting. A user can interact with one or more user interface windows presented to the user in display 218 under control of payee application 228 independently or through use of browser application 230 in an order selectable by the user. Thus, although some of the operational flows are presented in sequence, the various operations may be performed in various repetitions, concurrently, and/or in other orders than those that are illustrated. For example, a user may execute payee application 228 by selecting an icon representing payee application 228 or by selecting an icon representing browser application 230 and accessing an Internet portal. Thus, some operations performed by payee application 228 may be executed by processor 212 while others may be executed by second processor 312. Execution of payee application 228 may cause presentation in display 218 of a first user interface window, which may include a plurality of menus and selectors such as drop down menus, buttons, text boxes, hyperlinks, etc. associated with payee application 228 as understood by a person of skill in the art.

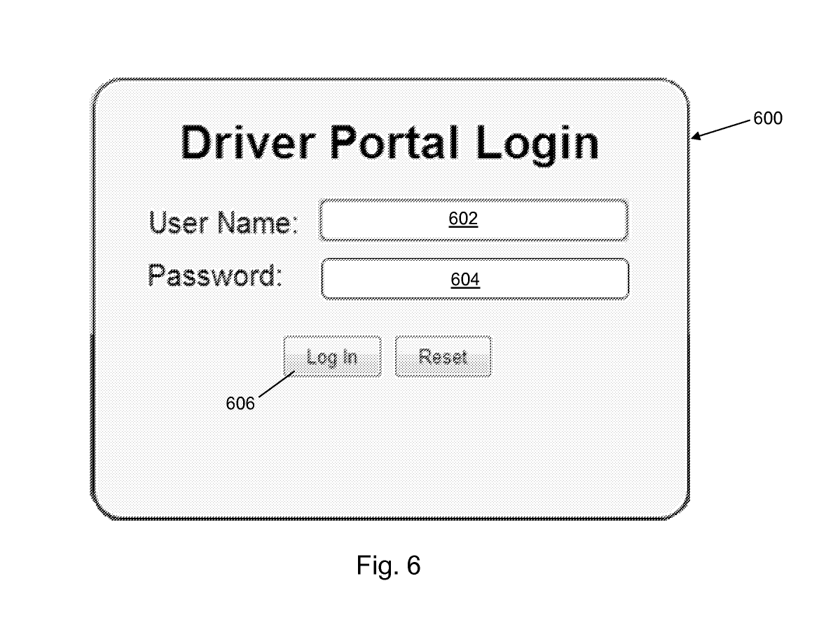

In an operation 500, user identification information such as a username and password may be received. For example, upon execution, payee application 228 may trigger presentation of a first user interface window 600 as shown with reference to FIG. 6. First user interface window 600 may include a username textbox 602, a password textbox 604, and a login button 606. The user may enter a username in username textbox 602 and a password in password textbox 604 and select login button 606, which triggers receipt of the user identification information by payee application 228. The user identification information may be received by browser application 230 and sent to payee application 228 by browser application 230 in an alternative embodiment. In another alternative embodiment, the user identification information may be received by browser application 230 and/or payee application 228 and sent to document processing application 322 for confirmation.

In an operation 502, confirmation of the user identification information is received. Of course, the user identification information may not be accepted which may trigger presentation of first user interface window 600 again. The user identification information may be used to identify the user to and confirm that the identified user properly has access to payee application 228.

In an operation 504, additional transaction information may be received. For example, the user may be requested to enter additional information that identifies the transaction for which the user is accessing payee application 228. The additional transaction information may include an order number, a driver code, a document type, etc. In an operation 506, the additional transaction information is sent to second computer-readable medium 310 and/or database 414 under control of payee application 228 and/or browser application 230. In alternative embodiments, some or all of the additional transaction information may be determined from the login information and/or a document uploaded to second computer-readable medium 310 and/or database 414, for example, using methods discussed herein.

In an operation 508, a request to create an electronic document is received. Of course, a request to create a plurality of electronic documents may be received. Receipt of the request may result in presentation of a user interface window that supports photographing of a paper document using camera 220, that supports scanning of a paper document using scanner 222, and/or that supports creation of an electronic document such as by using a word processing or spreadsheet type application. In an alternative embodiment, the electronic document may be created external to payee application 228 using camera 220, scanner 222, and/or a word processing, spreadsheet type, or other type application, etc.

In an operation 510, a selection of a created electronic document is received. For example, a user interface window may be presented that allows the user to browse to a directory or folder and select the created electronic document stored in the folder. Alternatively, the electronic document created in operation 508 may be selected automatically. The folder may be created on computer-readable medium 210 or another computer-readable medium accessible to payee system 200 through communication interface 208. Of course, a plurality of electronic documents may be selected. In an operation 512, the selected electronic document is sent or uploaded to second computer-readable medium 310 and/or database 414. Of course, a plurality of electronic documents may be sent or uploaded. Examples of transportation related documents include a proof of delivery document, a bill of lading, a receipt, a log sheet, etc.

As already explained, the various operations may be performed in various repetitions, concurrently, and/or in other orders than those that are illustrated. As an example, operations 504 and 506 may be performed after either of operations 508, 510, or 512.

In an operation 514, a notification message that status information is available or has been updated is received at payee system 200, for example, in a text message, in an email message, in a voicemail, or in any other type of message. The notification may be received without executing or logging into payee application 228.

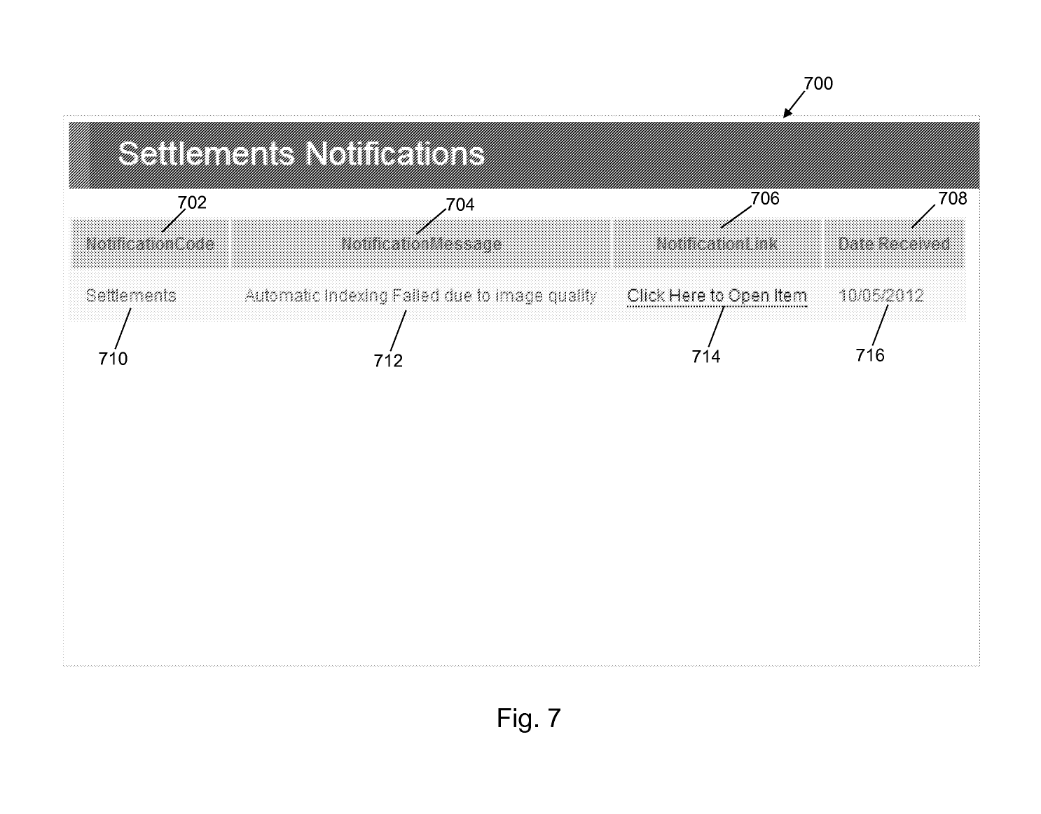

With reference to FIG. 7, a notification user interface window 700 is shown in accordance with an illustrative embodiment. Notification user interface window 700 may be included in the text message, the email message, or the other type of message received by payee system 200. The content of notification user interface window 700 further may be included in a voicemail message. Of course, the notification may be received at another payee system of the one or more payee systems 104 than payee system 200 from which the electronic document was uploaded. Notification user interface window 700 may include a plurality of notifications.

With reference to the illustrative embodiment of FIG. 7, notification user interface window 700 includes one or more rows of information that include a notification code column 702, a notification message column 704, a notification link column 706, and a receipt date column 708. Notification code column 702 indicates the type processing for which the notification was created. For example, notification code column 702 includes a first indicator 710 indicating that the first notification is associated with the processing of a settlement payment transaction. Notification message column 704 includes an indicator of the status of the processing of the transaction. For example, notification message column 704 includes a second indicator 712 indicating that the automatic indexing failed due to the image quality of the electronic document. Notification link column 706 includes a hyperlink 714 that provides access to the transaction data and/or electronic document. Receipt date column 708 indicates a receipt date 716 of the transaction data and/or electronic document.

With reference to FIG. 5, in an operation 516, a request to check a status of the processing of the uploaded electronic document is received. As an example, selection of hyperlink 714 by the user may result in receipt of a request to check the status. Alternatively, a user interface window presented under control of payee application 228 and/or browser application 230 may include a user interface item such as a menu item, a button, etc. selection of which indicates a request to check the status. Operations 500 and 502 may or may not be performed between operations 514 and operation 516. Additionally, the request may be received immediately after execution of operation 512, any time period after execution of operation 512, or after receipt of a notification message in operation 514, and thus may be irrespective of receipt of a notification message indicating that status information is available or has been updated. As a result, operation 502 may be followed by operation 516.

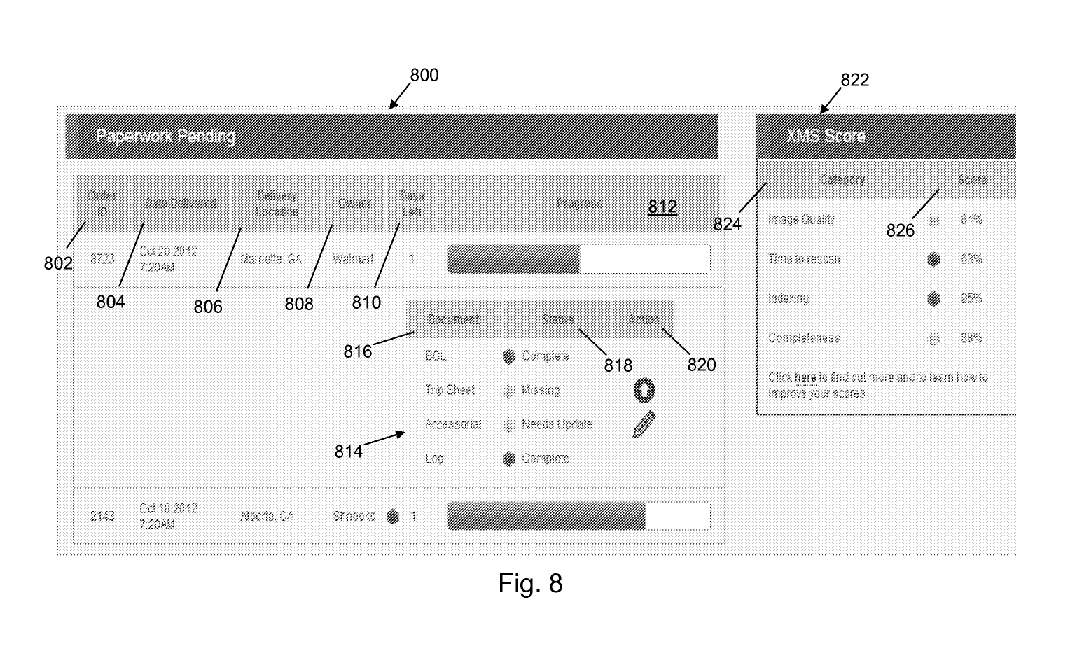

In an operation 518, the status information is presented in a user interface window such as a status user interface window 800 shown with reference to FIG. 8 in accordance with an illustrative embodiment. As an example, status user interface window 800 may be presented in response to selection of hyperlink 714 by the user. Status user interface window 800 may include a plurality of transactions for which the status is shown. Status user interface window 800 may include a status for pending transactions, for transactions on-hold, for completed transactions, etc.

With reference to the illustrative embodiment of FIG. 8, status user interface window 800 includes one or more rows of information that include an order number column 802, a delivery date column 804, a delivery location column 806, a delivery owner column 808, a days left column 810, a progress column 812, a document status list window 814, and a user scoring performance window 822. Each row is associated with a task for which a request for payment has been submitted also referred to herein as a payment transaction. Order number column 802 includes an indicator of the order number for the payment transaction. Delivery date column 804 includes an indicator of the date and time that the task was performed. Delivery location column 806 includes an indicator of the location at which the task was performed. Delivery owner column 808 includes an indicator of the owner of the goods. Days left column 810 includes an indicator of the number of days left to complete submission of the paperwork to receive payment in the next pay period. Progress column 812 includes a progress indicator of the progress of the payment transaction, i.e., completed, in process, on hold, etc. If the payment transaction is in process, the progress indicator may indicate a percentage of completion.

Document status list window 814 includes one or more rows of information that include a document name column 816, a document processing status column 818, and an action column 820. Each row is associated with a document submitted with the payment transaction. Document name column 816 includes an indicator of the name of the document. Document processing status column 818 includes an indicator of the processing status of the associated document. For example, in an illustrative embodiment, the status indicator may indicate that the processing of the document is complete, the document is missing, or the information associated with the document needs updating, etc. Action column 820 includes an indicator of the action needed to complete processing of the document, if any. For example, in an illustrative embodiment, the action indicator may indicate that the document needs to be uploaded, that the document or data associated with the document needs editing, or that the document needs replacement or deletion.

User scoring performance window 822 includes one or more rows of information that include a category column 824 and a score column 826. Each row is associated with a scoring category associated with submitting documents with the payment transaction. User scoring performance window 822 provides the user with information related to how well the user avoids submission issues. Category column 824 includes an indicator of the type of issue. Example categories include image quality issues, time to rescan issues, indexing errors, completeness errors, etc. Score column 826 includes an indicator of a numerical score associated with how well the user does in avoiding each category of issue. An overall score may be used to evaluate whether or not the user can continue to use payee application 228 and/or document processing application 322. Thus, as an example, if the user repeatedly submits documents with an inadequate image quality, the user may no longer be permitted to submit documents to payee application 228 and/or document processing application 322.

With continuing reference to FIG. 5, processing may continue in operation 504, 508, or 510 depending on any issue identified based on the presented status information. For example, if a document is indicated as missing, processing may continue at operation 508 if the document was not created, or at operation 510, if the document was created, but the user forgot to upload the document. As another example, if the information associated with the document needs updating or editing, processing may continue at operation 504 to create the information such as the order number, the bill of lading or purchase order, the date or time, etc.

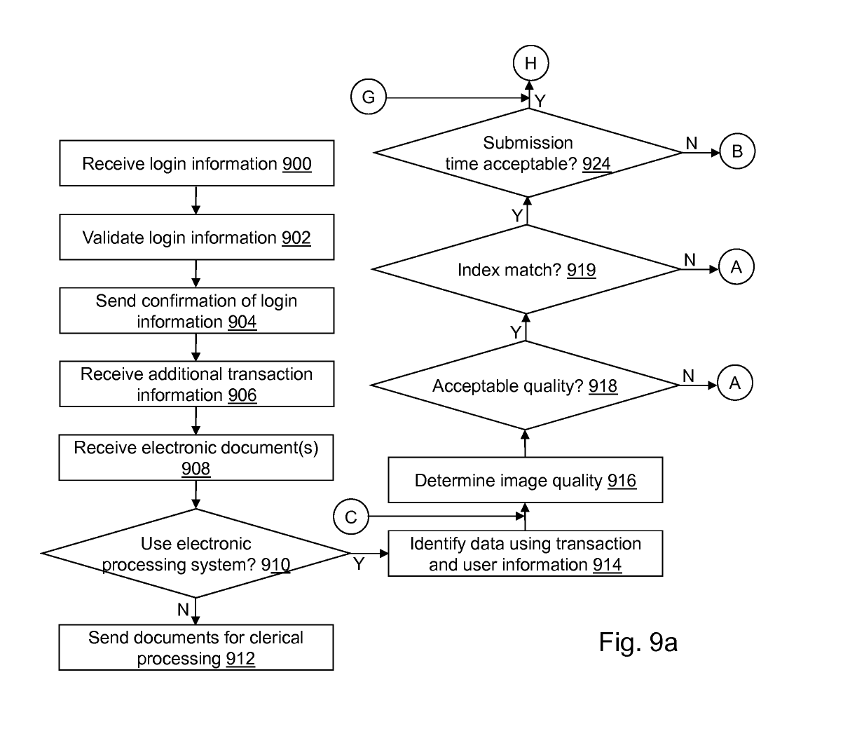

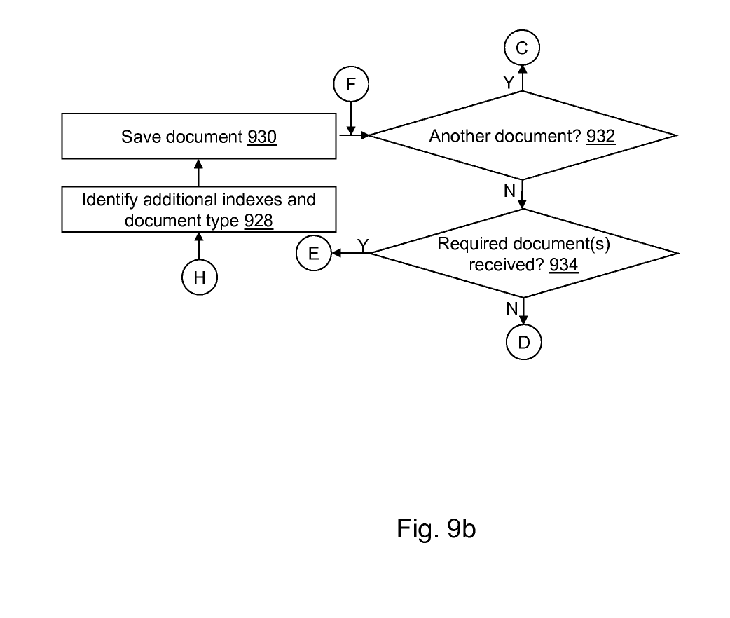

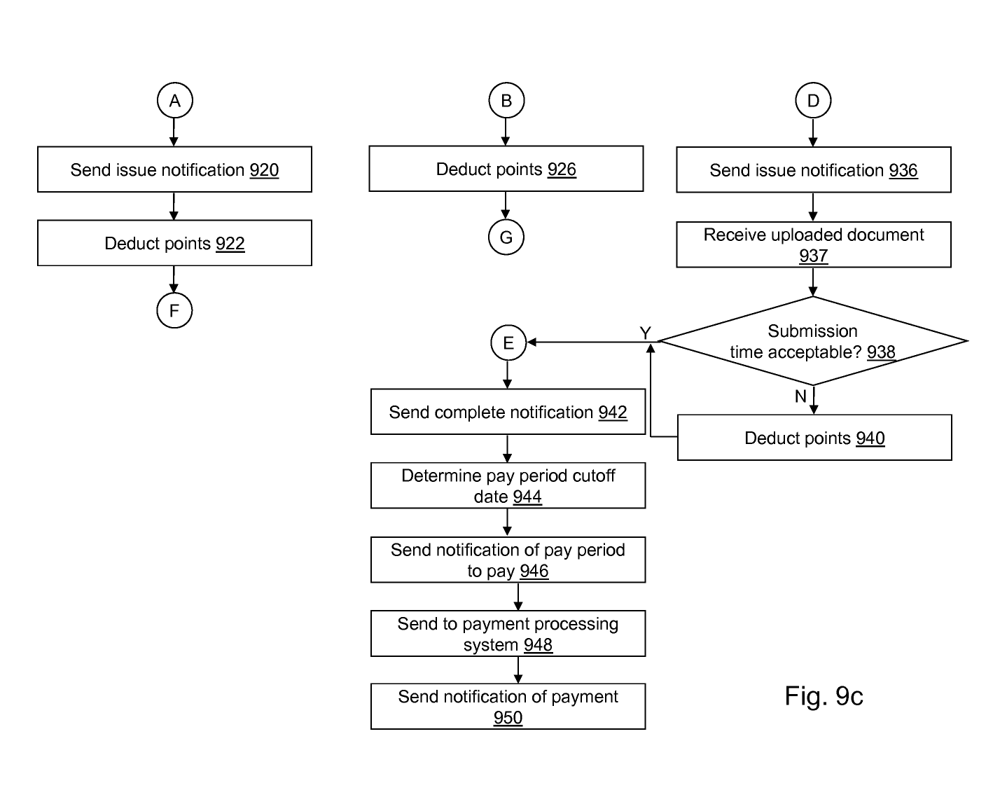

With reference to FIGS. 9a, 9b, and 9c, example operations associated with document processing application 322 are described. Additional, fewer, or different operations may be performed depending on the embodiment. For example, document processing application 322 may provide additional functionality beyond the capability to process documents associated with payment for performance of a task such as the delivery of goods. The order of presentation of the operations of FIGS. 9a, 9b, and 9c is not intended to be limiting. A user can interact with one or more user interface windows presented to the user in second display 318 or display 218 under control of document processing application 322 in an order selectable by the user. Thus, although some of the operational flows are presented in sequence, the various operations may be performed in various repetitions, concurrently, and/or in other orders than those that are illustrated.

A user may execute payee application 228 on payee system 200, which triggers execution of document processing application 322 on payer system 300. Thus, document processing application 322 on payer system 300 may control creation of one or more of the user interface windows described previously. As understood by a person of skill in the art, payee application 228 and document processing application 322 may be integrated in various ways to provide the described functionality.

In an operation 900, the user identification information such as the username and password may be received. For example, document processing application 322 may receive the username entered in username textbox 602 and the password entered in password textbox 604 after user selection of login button 606. In an operation 902, the user identification information is evaluated to determine if the user identification information is valid. If the user identification information is valid, confirmation of the user identification information is sent in an operation 904 to allow the user access to document processing application 322. Of course, the user identification information may not be valid triggering a renewed request to enter the user identification information.

In an operation 906, additional transaction information associated with the user's payment transaction may be received. For example, the additional transaction information may include, but is not limited to, an order number, a driver code or number, a shipper code, a consignee code, a document type, pick-up address, delivery address, estimated miles driven, etc. Some or all of the additional transaction information may include one or more index keys used to identify additional data associated with the task performance and stored in settlement system 100. Example index keys may include the order number and the driver number. The order number and the driver number may have been entered, for example, in operation 506. As another option, the email address of the user may be determined using the user identification information and used as a primary index to determine the current load number or other transaction information associated with the user in settlement system 100.

In an operation 908, an electronic document is received. A plurality of electronic documents may be received in operation 908 or through successive performance of operations 906 and 908. In an illustrative embodiment, the order number and/or the driver number may be determined using any of optical character recognition (OCR), intelligent character recognition (ICR), optical mark recognition (OMR), bar code reading, etc. performed on the electronic document instead of manual entry in operation 506.

In an operation 910, a determination is made concerning whether or not the uploaded document is to be processed using electronic processing or clerical processing. For example, certain users may not be allowed to use electronic processing because too many issues have been identified during the processing of previous transactions. If the user is not allowed to use electronic processing, the received document is sent to a device for manual processing by clerical personnel in an operation 912.

In manual processing by clerical personnel, an individual reviews the electronic documents associated with the task and obtains a primary index value, which may be an order number written on the electronic document or a coversheet. The clerical person enters the primary index value into document processing application 322. The electronic documents and additional transaction information is associated with the index value so that the documents can be retrieved and routed based on the data entered as understood by a person of skill in the art.

If the user is allowed to use electronic processing, processing continues in an operation 914. In operation 914, data is identified using the received electronic document and the additional transaction information. For example, the one or more index keys may be used to identify additional data associated with the task performance and stored in settlement system 100 such as in database 414. The one or more index keys may be used to validate that the correct order number is written on the received electronic documents. The identified data may include additional index values retrieved from settlement system 100 and applied to the received electronic documents.

In an operation 916, the image quality of the received electronic document is determined. The electronic document may be preprocessed to automatically improve image quality by scanning the document for customized enhancements. In an illustrative embodiment, an image clarity and readability score is defined for the electronic document. Example criteria include the existence of speckles, evaluation of grey fill, file size, etc.

In an operation 918, a determination is made concerning whether or not the image is of acceptable quality. For example, the determination may be made by comparing the image clarity and readability score to a defined threshold. If the image clarity and readability score is below the defined threshold, the electronic document may be selectively enhanced and rescored. If the image clarity and readability score of the enhanced image now exceeds the defined threshold, the enhanced image of the electronic document is saved to replace the original electronic document.

If the determination is made that the image is of acceptable quality, processing continues in an operation 919. In operation 919, a determination is made concerning whether or not there is an index match. For example, the order number identified in operation 906 may be used as an index and compared to the order number identified in operation 914 to confirm that the numbers match. Of course, other transaction information identified in operation 906 may be used for comparison with the data identified in operation 914 to confirm the accuracy of the transaction information provided in operation 906. Thus, other data items other than the order number may be used as the index. Additionally, more than one data item may be used. If the data item used as the index does not match, processing continues in an operation 920. If the data item used as the index does match, processing continues in an operation 924.

If the determination is made that the image is not of acceptable quality, processing continues in operation 920. In operation 920, the user is sent a notification message that indicates there is an issue with the image quality of the electronic document or that the index does not match and that the electronic document/transaction information should be resubmitted. In an operation 922, points are deducted from a user point system used to determine if the user can use the electronic processing system. The image quality score for the user may further be updated. Processing continues in operation 932 to process the next electronic document if multiple electronic documents were uploaded.

In operation 924, a determination is made concerning whether or not a submission time for the electronic document is acceptable. If the determination is made that the submission time for the electronic document is not acceptable, processing continues in an operation 926. In operation 926, points are deducted from the user point system used to determine if the user can use the electronic processing system. The purpose of the point system is to encourage task performers such as truck drivers to submit their paperwork as quickly as possible and as accurately as possible. As an example, a submission time of the electronic document more than 24 hours after completion of the task may be considered unacceptable. The submission time since a request to resubmit a document may be kept separately to determine and evaluate a time to resubmit as part of the user scoring system.

If the determination is made that the submission time for the electronic document is acceptable, processing continue in an operation 928. In operation 928, additional indexes and a document type for the electronic document are identified from the electronic document. For example, a document type may be defined for the electronic document by the user in operation 504 using a drop down list. As another option, an OCR engine may be trained to identify the document type based on a template. Additional indexes may be defined for the electronic document by the user in operation 504 or may be extracted from the electronic document automatically using OCR, ICR, OMR, or a read bar code based on the determined document type and knowledge about the layout of the document type. The additional indexes may include, but are not limited to, the bill of lading number, the tractor number, the trailer number, bill to code, etc.

In operation 930, the electronic document is saved to second computer-readable medium 310, third computer-readable medium 410, and/or database 414 for further processing.

In operation 932, a determination is made concerning whether or not another electronic document was received and should be processed. If the determination is made that another electronic document was received, processing continues in operation 916. If the determination is made that another electronic document was not received, processing continues in an operation 934. In operation 934, a determination is made concerning whether or not the required documents have been received to complete processing of the payment transaction. If the determination is made that the required documents have not been received, processing continues in an operation 936. If the determination is made that the required documents have been received, processing continues in an operation 942. Database 414 may include information that defines which documents are needed to complete a payment transaction depending, for example, on the employer of the user.

In operation 936, an issue notification is sent to the user indicating that one or more documents are missing from the payment transaction. In operation 937, an electronic document is received, for example, after a subsequent user execution of operation 512. In operation 938, a determination is made concerning whether or not a submission time for the electronic document is acceptable. If the determination is made that the submission time for the electronic document is not acceptable, processing continues in an operation 940. In operation 940, points are deducted from the user point system used to determine if the user can use the electronic processing system. As an example, a submission time of the electronic document more than 24 hours after completion of the task may be considered unacceptable. The time since the request to provide a missing document may also be kept to determine a time for submission after a notification separate from the initial submission time.

If the determination is made that the submission time for the electronic document is acceptable, processing continues in operation 942. In operation 942, a notification is sent confirming that a proper submission of the documents associated with the payment transaction has been completed. For example, an email or text message or a voicemail may be automatically sent to the user at payee system 200 or another payee system associated with the user. The message may indicate that the documents have been processed for completeness and legibility and that further processing by the payment system is proceeding.

In an operation 944, a pay period cutoff time is determined. In an operation 946, a notification is sent indicating the pay period in which payment for the task completion and payment transaction will be made. For example, if the payment transaction is completed before a pay period cutoff time, payment may be included in the current pay period; if the payment transaction is completed after the pay period cutoff time, payment may be included in the next pay period.

In an operation 948, the payment transaction information is forward to a payment processing system for further processing. Of course, the payment processing system may be integrated with document processing application 322. As another option, the payment processing system may be an independent application and computing system in communication with payer system 300. In an operation 950, a notification message indicating payment has been made to the user is sent.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”. Still further, the use of “and” or “or” is intended to include “and/or” unless specifically indicated otherwise. The illustrative embodiments may be implemented as a method, apparatus, or article of manufacture using standard programming and/or engineering techniques to produce software, firmware, hardware, or any combination thereof to control a computer to implement the disclosed embodiments.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A computer-readable medium having stored thereon computer-readable instructions that when executed by a computing device result in the computing device:
receiving user identification information for a user;
receiving an electronic document associated with a payment transaction for a task completed by the user;
identifying electronic processing criterion associated with the payment transaction based on the received user identification information;
determining if the received electronic document satisfies the identified electronic processing criterion; and
if the received electronic document does not satisfy the electronic processing criterion, sending an issue notification message to the user identifying an issue associated with the payment transaction.

2. The computer-readable medium of claim 1, wherein the computer-readable instructions further result in the computing device sending a notification message to the user indicating that a proper submission of the document associated with the payment transaction has been completed if the received electronic document satisfies the electronic processing criterion.

3. The computer-readable medium of claim 1, wherein the task is associated with a delivery of goods to a destination.

4. The computer-readable medium of claim 1, wherein the electronic document is an image of a paper document.

5. The computer-readable medium of claim 4, wherein the computer-readable instructions further result in the computing device determining a clarity and readability score for the image.

6. The computer-readable medium of claim 5, wherein the identified electronic processing criterion comprise a defined clarity and readability threshold.

7. The computer-readable medium of claim 6, wherein the computer-readable instructions further result in the computing device comparing the determined clarity and readability score to the defined clarity and readability threshold to determine if a quality of the image is acceptable.

8. The computer-readable medium of claim 7, wherein the issue notification message indicates that the quality of the image is unacceptable if the quality of the image is determined to be unacceptable based on the comparison.

9. The computer-readable medium of claim 8, wherein the computer-readable instructions further result in the computing device receiving a second electronic document associated with the payment transaction for the task completed by the user in response to the issue notification message.

10. The computer-readable medium of claim 1, wherein the identified electronic processing criterion comprise a number and a type of electronic documents associated with the payment transaction based on the received user identification information.

11. The computer-readable medium of claim 10, wherein the computer-readable instructions further result in the computing device comparing the received electronic document to the number and the type of electronic documents associated with the payment transaction to determine if all of the electronic documents have been received.

12. The computer-readable medium of claim 11, wherein the issue notification message indicates that a document has not been received if all of the electronic documents have not been received based on the comparison.

13. The computer-readable medium of claim 12, wherein the computer-readable instructions further result in the computing device receiving a second electronic document associated with the payment transaction for the task completed by the user in response to the issue notification message.

14. The computer-readable medium of claim 1, wherein the identified electronic processing criterion comprise an identified index value.

15. The computer-readable medium of claim 14, wherein the computer-readable instructions further result in the computing device:
receiving an index value associated with the electronic document; and
comparing the received index value to the identified index value;
wherein the issue notification message indicates an indexing error if the received index value does not match the identified index value based on the comparison.

16. The computer-readable medium of claim 15, wherein the identified index value is identified by processing the received electronic document using a character or mark recognition process.

17. The computer-readable medium of claim 16, wherein the identified index value is identified by reading a bar code from the received electronic document and processing the bar code.

18. The computer-readable medium of claim 17, wherein the computer-readable instructions further result in the computing device receiving a second electronic document associated with the payment transaction for the task completed by the user in response to the issue notification message.

19. A system comprising:
a processor;
a computer-readable medium operably coupled to the processor, the computer-readable medium having computer-readable instructions stored thereon that, when executed by the processor, cause the system to
receive user identification information for a user;
receive an electronic document associated with a payment transaction for a task completed by the user;
identify electronic processing criterion associated with the payment transaction based on the received user identification information;
determine if the received electronic document satisfies the identified electronic processing criterion; and
if the received electronic document does not satisfy the electronic processing criterion, send an issue notification message to the user identifying an issue associated with the payment transaction; and
a communication interface operably coupled to the processor and configured to receive the user identification information and the electronic document and to send the issue notification message.

20. A method of providing feedback to a user concerning a settlement process, the method comprising:
receiving, by a computing device, user identification information for a user;
receiving, by the computing device, an electronic document associated with a payment transaction for a task completed by the user;
identifying, by the computing device, electronic processing criterion associated with the payment transaction based on the received user identification information;
determining, by the computing device, if the received electronic document satisfies the identified electronic processing criterion; and
if the received electronic document does not satisfy the electronic processing criterion, sending, by the computing device, an issue notification message to the user identifying an issue associated with the payment transaction.
